(19) United States
(12) Patent Application Publication
(10) Pub. No.: US 2010/0204056 A1
(43) Pub. Date: Aug. 12, 2010

(54) QUALITY-CONTROL AND ALIGNMENT ELEMENT FOR ASSAY SUBSTRATES

(76) Inventors: James M. Takeuchi, Woodstock, GA (US); Shawn R. Feaster, Duluth, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/641,990

(22) Filed: Dec. 18, 2009

Related U.S. Application Data
(60) Provisional application No. 61/151,234, filed on Feb. 10, 2009.

(51) Int. Cl. C40B 30/04; C40B 50/14; C40B 40/10; C40B 40/12

(52) U.S. Cl. 506/9; 506/30; 506/18; 506/19

(57) ABSTRACT

A method for fabricating and assessing the quality of printing on substrates used for chemical or biological array testing, and method for ascertaining relative consistency of the deposit reproducibility is described. Generally, the method involves: providing a substrate, providing a solution mixture of a capture moiety and a colorant; depositing an amount of said solution mixture onto said substrate, monitoring the substrate such that the visible indicator colorant manifests in a co-extensive fashion as with the capture moiety on the substrate. In another aspect, the invention relates to a sensor or assay device comprising a physical complex of a number of capture agents and an amount of colorants adhere to least a part of a surface of a substrate.

Applicants hereby claim priority from presently copending U.S. Provisional Application No. 61/151,234 entitled “QUALITY-CONTROL AND ALIGNMENT ELEMENT FOR ASSAY SUBSTRATES” and filed on Feb. 10, 2009, in the names of James M. Takeuchi and Shawn R. Feaster (Docket No. 64391594US01).

### FIELD OF INVENTION

The present invention relates to an assay device having printed arrays and method for controlling the quality of its fabrication and facilitating its use. In particular, the invention pertains to a means by which one can visually monitor the alignment and quality of printed binding sites on a substrate.

### BACKGROUND

Surface-mediated assays, such as lateral-flow test devices, are a well accepted format by which to accurately detect the presence or concentration of a specific analyte of interest from a physiological sample. Generally these methods have been limited to purely qualitative or sometimes at best, semi-quantitative results. A quickly growing trend in the industry, however, is a shift towards developing fully quantitative tests. In order to achieve these higher order benefits from a lateral flow platform, not only does the accuracy and precision of the actual test need to improve, but also too the manufacturing and assembly processes. When using an optical system to quantify the intensity of a zone of color on a test strip, two critical aspects are the quality of the color zone and the location of the color zone relative to the optical detection system.

Lateral flow diagnostic or assay devices commonly employ an area on the test strip that generates a visual color change in either the presence or absence of a biomarker of interest. This kind of indicator is used, for instance, in over-the-counter pregnancy test devices. Typically, these detection zones are formed on the membrane of the test strip with antibodies specific for the analyte of interest. These antibodies are often deposited onto the test strip substrate using a liquid handling station at known concentrations to form a pattern or stripes across the width of the test strip. Upstream of this first region with antibodies is situated another, second region of antibodies specific for the analyte of interest, called the conjugate that are bound or conjugated to a visible label (e.g., colloidal gold, latex beads, etc.). In the presence of a test sample, the conjugate and the analyte of interest form a “sandwich” with the detection zone antibodies and thus, a colored stripe forms on the test strip. The intensity of the color band corresponds to the number of bound detection antibodies and thus correlates to the concentration of analyte in the test sample.

A variety of optical detection methods (transmission, reflection, etc.) have been demonstrated to successfully quantify analyte concentration from a given sample by measuring the intensity of color on a lateral flow test strip. Typical systems use a combination of light sources and photo detectors that correspond to zones of color on the test strip. While effective, these systems ideally require a homogeneous region of color as well as a known location on the test strip in reference to the optical readers so as to yield the precision required to produce a quantitative test. At times a misalignment or differentiation in the amount of capture moieties on the substrate can cause the performance of the assay to either not register properly with the optical reader or to be partially or totally inoperative. When considering the complexities in the biochemistry and the potential tolerance stack-ups with manufacturing and assembly, these are not trivial issues. Given the problems associated with the current processes, a new approach for fabricating arrays is needed, which the present invention endeavors to provide a solution that is both simple and economical to use.

### SUMMARY OF THE INVENTION

The present invention pertains to a method for fabricating and assessing the quality of printing on substrates used for chemical or biological array testing. The method involves: providing a substrate, providing a solution mixture of a capture moiety and a colorant; depositing an amount of said solution mixture onto said substrate to manifest a visible indicator of the location and presence of said capture moiety colorant as a marker for the co-extensive area of on the substrate.

In another aspect, the invention relates to a sensor or assay device comprising a physical complex of a number of capture agents and an amount of colorants adhere to least a part of a surface of a substrate. The array substrate can be employed to detect a number of biological or chemical moieties when binding with the printed capture agents on the substrate surface. The present inventive method can minimize or eliminate the need for a homogeneous region of color as well as a known location on the test strip in reference to the optics in order to yield the precision.

The present invention also relates to a method for ascertaining the relative quality of a printed substrate and consistency of its reproducibility. The quality control protocol involves: providing a substrate; providing a solution mixture of a capture moiety and a colorant; depositing an amount of said solution mixture onto said substrate; monitoring by an optical means said substrate for alignment and quality of printed binding sites on said substrate. One detects for indications of a presence and location of said capture moiety and colorant are co-extensive area on the substrate. The optical means is either a human naked eye or an electronic or digital camera or scanner.

Additional features and advantages of the present three-dimensional sensor or assay device and associated absorbent articles containing such a sensor will be described in the following detailed description. It is understood that the foregoing general description and the following details description and examples are merely representative of the invention, and are intended to provide an overview for understanding the invention as claimed.

### BRIEF DESCRIPTION OF FIGURES

FIGS. 1A-C are three panels illustrating the relative fidelity or quality of a printed according to the present invention. Each figure represents a step or phases of printing the substrate according to the present invention.

FIGS. 2A-D are examples of images of printed substrates according to the present invention.

FIG. 3 is a graph showing the relative gradient printing for the four samples in FIG. 2.

FIGS. 4A and 4B are another set of printed lines on nitrocellulose substrate according to an embodiment of the present invention, at 1:3 and 1:1 ratios, respectively, using an optical system for detecting the relative stripe placement.

FIG. 5 is graph that shows the relative position and off-sets of each printed line from a standard position.

### DETAILED DESCRIPTION OF THE INVENTION

The present invention pertains to a means to quickly and efficiently assess the quality of a color stripe, as well as the position of the stripe or an area of interest on a test substrate by incorporating one or more colorants into a capture moiety solution. In particular, according to one aspect, the invention relates to a method to assess the quality and placement of printed targets or moieties on a lateral flow test strip substrate using one or more colorants that is incorporated into the antibody solution. The capture moiety can be an antibody, protein, carbohydrate, or other cellular membrane component. The colorant can be a dye. The substrate can be made from a variety of different kinds of materials, such as either a glass, ceramic, metallic, or cellulose-based material. Typically, the substrate can be a nitrocellulose material when used for lateral flow assays. Beyond applications for a quantitative lateral flow test, the addition of colored dye to an antibody solution can be used in array fabrication for general quality assurance/quality check (QA/QC). The dye or colorant serves as a visual indicator for invisible capture agent moieties. The size, area, and physical extent that the colorant and capture agent moieties are deposited on to the substrate are co-extensive or co-terminus with each other. That is, the colorant molecules and capture agent moieties overlap each other completely; to the same physical extent and surface area.

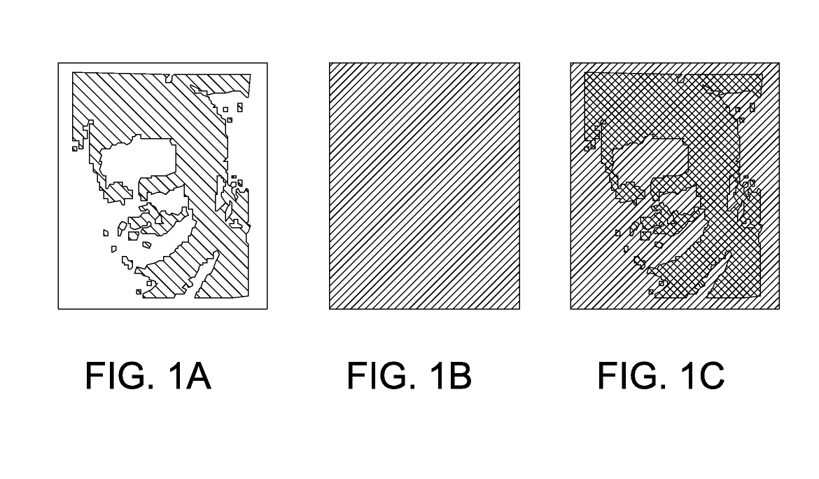

FIG. 1 shows three panels of a substrate which can be used in the manufacture of lateral flow arrays. Whereas normally stripes or lines or areas of interests for arrays are created, for purposes of illustration of the present invention, the substrate is printed with an image of a human face. FIG. 1A shows the substrate that is prepared and coated with a capture moiety and a colorant. (The binary image is printed with a JetLab II: 10 mg/mL BSA, FD&C Green Dye, HF120 nitrocellulose.) FIG. 1B shows the substrate of FIG. 1A developed with a colorant (TBS diluent through the image), and FIG. 1C shows the resultant image stained with colloidal blue stain. The image that was applied in the initial printing in FIG. 1A is reproduced with high fidelity in FIG. 1C. This feature can be a great advantage when fabricating printed substrates for lateral flow assay devices.

Unlike other approaches, according to the invention, the colored dye or ink is used primarily as a quality control/quality assurance tool and secondly as a methodology to facilitate device assembly. In the present system, one uses printed ink to infer the quality of the printed feature prior to use or that the feature is correctly located within test housing or the like. Additionally, the ink could be used to infer that the test has run by its translocation. As envisioned, the system encodes no information save the quality of the printed feature.

From a consumer's perspective, visible lines could serve ease test interpretation by serving as an indication of where to be looking on the device for the results. In other words, a predetermined printing pattern can serve as a key to interpret the assay surface, before and after the running of the test. According to an embodiment, the system incorporates red gold labels and corresponding green light sources (LEDs, 565 nm), but one should be understood that other optical combinations are possible as well. Stripe quality (homogeneity across the entire width of the test strip) is an important factor for accurate optical measurements. Dispensing the antibody solution onto the test strip with a liquid handling workstation is a factor that can affect stripe quality. Adding a colored dye to the antibody solution allows for a quick visual assessment of the line quality after a stripe or other pattern is deposited on the substrate.

Problems such as uneven distribution, splattering, non-uniform drying, etc. can be identified before assembly to ensure an accurate test. The dye should be soluble in the specific sample or diluent being used so as to not affect antibody binding, and thus the quality of the test. The dye can be any color, but in one embodiment, it is the same color as the light source so as to allow for a “blank” measurement of the membrane prior to running the test. Incorporating a dye to the antibody stripe has shown no negative effect to the performance of the assay. The dye travels to an absorptive sink downstream of the stripe with either sample or the diluent solution and does not affect the optical measurements. Depending on the application, it is also possible for the dye to remain fixed in the detection zone throughout the course of the assay.

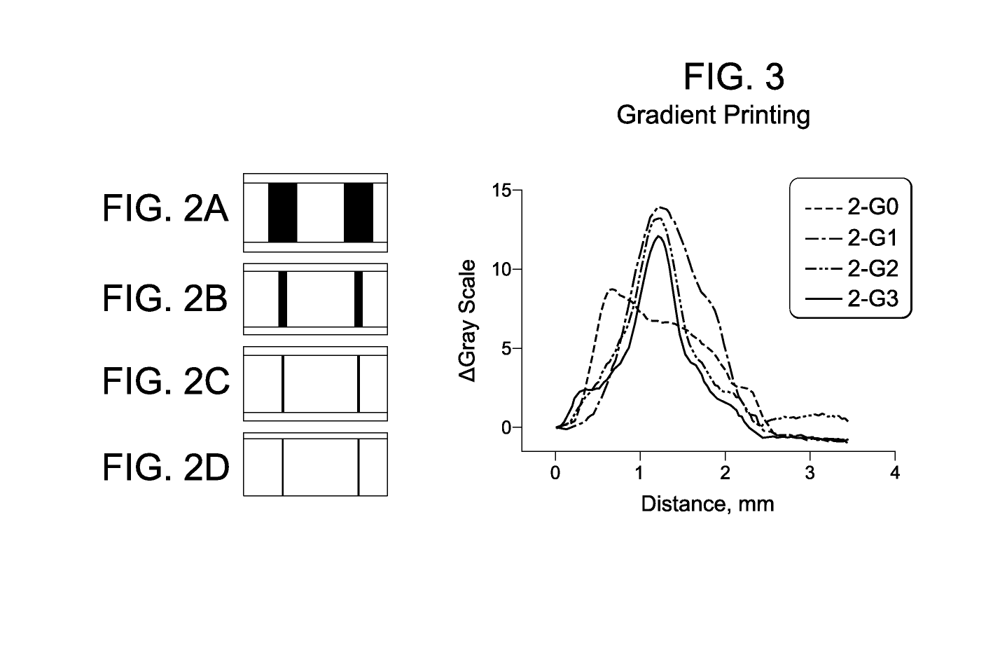

FIGS. 2A-2D shows examples of four array substrates fabricated according to the present inventive method. FIG. 3 is a graph illustrating the relative change of the gradient in gray-scale for the printed samples of FIG. 2.

Another important factor to achieve quantization with lateral flow is the location of the color zone in relation to a fixed optical detection system. Best results are achieved when the center of the test stripe is centered to the light source. If the stripe shifts due to imprecise dispensing methods, quantitative measurements become very unreliable. Adding a complementary color dye (e.g. red for a green light source) to the antibody solution prior to striping can provide a means to check for proper stripe position before running the assay. After the system has been completely assembled (test strip, optics, housing, etc.), a measurement can be taken that can determine if proper alignment between the strip and the optics has been achieved. As the stripe moves farther away from its specified position, the amount of light reaching the photo-detector will increase.

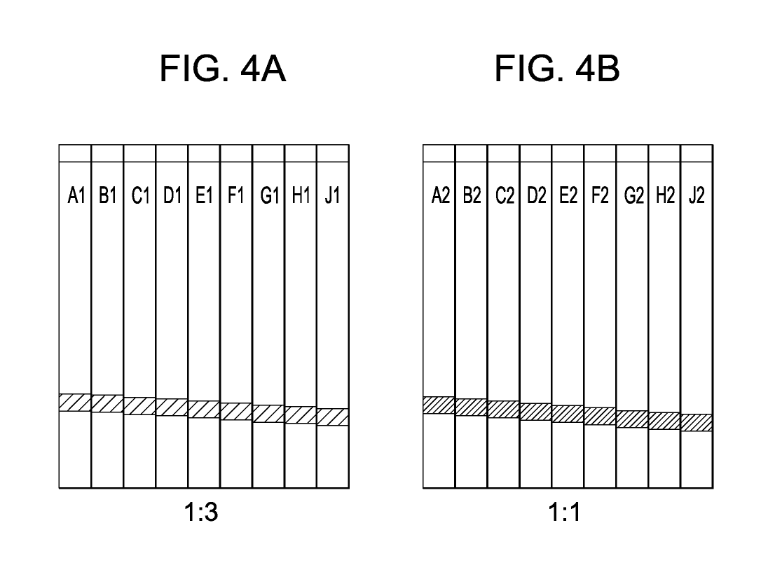

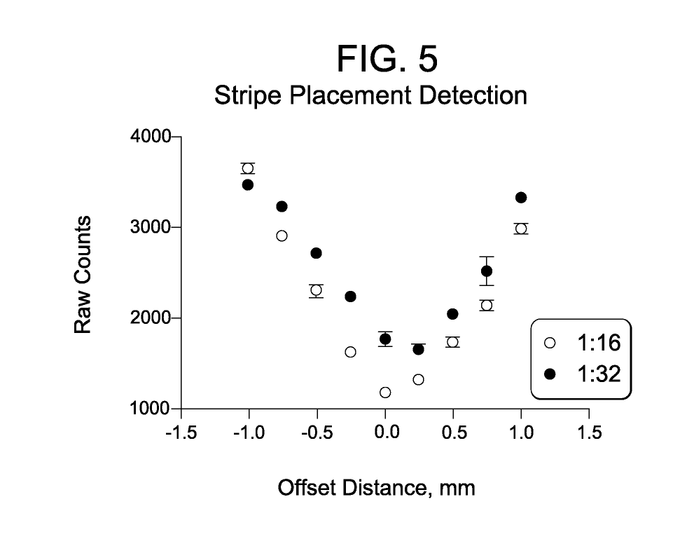

Experiments show a high sensitivity to shifts in placement (<0.5 mm). For instance, the accompanying FIGS. 4 and 5 summarize the data. Again, the dye should be soluble in either the sample or the diluent solution so it is washed away from the detection zone as the assay is run. In this way it can provide a quality check before the assay is run but not affect the actual test measurements. In addition to solubility, the dye could become transparent or undergo a color change as the assay is performed. It should be noted that all of the above methods can be integrated into standard manufacturing and assembly procedures. Many such tests are manufactured in a continuous web system employing machine vision, which is certainly applicable to this invention.

The present invention has been described both generally and in detail by way of examples and the figures. Persons skilled in the art, however, can appreciate that the invention is not limited necessarily to the embodiments specifically disclosed, but that substitutions, modifications, and variations may be made to the present invention and its uses without departing from the spirit and scope of the invention. Therefore, changes should be construed as included herein unless the modifications otherwise depart from the scope of the present invention as defined in the following claims.

We claim:

1. A method for fabricating an assay substrate comprising: providing a substrate; providing a solution mixture of a capture moiety and a colorant; depositing an amount of said solution mixture onto said substrate to manifest a visible indication of the location and presence of said capture moiety colorant as a marker for a co-extensive area on the substrate.

2. The method according to claim 1, wherein said substrate is a glass, ceramic, metallic, or cellulose-based material.

3. The method according to claim 2, wherein said substrate is a nitrocellulose material.

4. The method according to claim 1, wherein said colorant is a dye.

5. The method according to claim 1, wherein said colorant is a gold label.

6. The method according to claim 1, wherein said capture moiety is an antibody, protein, carbohydrate, or cellular membrane component.

7. An assay device comprising a physical complex of a number of capture moieties and an amount of colorants adhere to least a part of a surface of a substrate, said capture moieties being made optically manifest to indicate presence and relate location of said capture moiety as a marker for a co-extensive area printed on said substrate.

8. The assay device according to claim 6, wherein said substrate is a glass, ceramic, metallic, or cellulose-based material.

9. The assay device according to claim 7, wherein said substrate is a nitrocellulose material.

10. The assay device according to claim 6, wherein said colorant is a dye.

11. The assay device according to claim 6, wherein said colorant is a gold label.

12. The assay device according to claim 6, wherein said capture moiety is an antibody, protein, carbohydrate, or cellular membrane component.

13. A method for regulating quality control on a printed substrate, the method comprising: providing a substrate; providing a solution mixture of a capture moiety and a colorant; depositing an amount of said solution mixture onto said substrate; monitoring by an optical means said substrate for alignment and quality of printed binding sites on said substrate.

14. The method according to claim 13, further comprising detecting for indications of a presence and location of said capture moiety and colorant are co-extensive area on the substrate.

15. The method according to claim 13, wherein said optical means is either a human naked eye or an electronic or digital camera or scanner.

16. The method according to claim 13, wherein said substrate is a glass, ceramic, metallic, or cellulose-based material.

17. The method according to claim 16, wherein said substrate is a nitrocellulose material.

18. The method according to claim 13, wherein said colorant is a dye.

19. The method according to claim 13, wherein said colorant is a gold label.

20. The method according to claim 13, wherein said capture moiety is an antibody, protein, carbohydrate, or cellular membrane component.
